(19) United States
(12) Patent Application Publication
(10) Pub. No.: US 2005/0193145 A1
(43) Pub. Date: Sep. 1, 2005

(54) Providing a portion of an electronic mail message based upon digital rights

(75) Inventors: Michael W. Brown, Georgetown, TX (US); Michael A. Paolini, Austin, TX (US); Newton J. Smith, Austin, TX (US)

Correspondence Address: IBM CORPORATION (WMA);C/O WILLIAMS, MORGAN & AMERSON, P.C., 10333 RICHMOND, SUITE 1100, HOUSTON, TX, 77042, US

(73) Assignee: INTERNATIONAL BUSINESS MACHINES CORPORATION, ARMONK, NY (US)

(21) Appl. No.: 10/788,999

(22) Filed: Feb. 26, 2004

(51) Int. Cl. G06F 7/00; G06F 17/00; G06F 15/173

(52) U.S. Cl. 709/238

(57) ABSTRACT

A method and an apparatus for providing a portion of an electronic mail message based upon digital rights. The method includes determining that a user is authorized to receive less than all of an electronic mail message based on at least one digital right associated with the electronic mail message, selecting a portion of the electronic mail message that the user is authorized to receive, and providing the selected portion of the electronic mail message.

### BACKGROUND OF THE INVENTION

1. Field of the Invention

This invention relates generally to electronic mail messaging, and, more particularly, to providing a portion of an electronic mail message based upon digital rights.

2. Description of the Related Art

Electronic mail has become a central feature of modern life and users have come to expect to receive electronic mail messages at any time and in virtually any place. For example, during the course of one day of travel, a user may receive electronic mail messages at a home desktop computer in the early morning, an office desktop computer in midmorning, via a cell phone or personal digital assistant in a taxi on the way to the airport, on a laptop computer via a wireless local area network while waiting in the airport lounge, via an in-flight telephone on the airplane, and in a hotel room via a high-speed Internet connection provided by the hotel at the end of the day.

Thus, depending on the circumstances, electronic mail messages may be transmitted and/or received by a wide variety of devices at any given time. In addition to the aforementioned end-user devices, such as desktop computers, laptop computers, cell phones, personal digital assistants, and the like, electronic mail messages typically also pass through a variety of network servers, network switches, hubs, routers, transmission lines, wireless transmission media, modems, interface cards, and the like. The transfer rates of these devices and/or media can vary by many orders of magnitude. For example, a laptop computer's modem may be limited to a transfer rate of 56K bits per second, a cable modem may easily provide data at a transfer rate of 1-2 megabits per second, and a T-3 connection may provide data at a transfer rate as high as 40 megabits per second.

The complexity and size of electronic mail messages has increased roughly in proportion with the available transfer rate. Early electronic mail message systems relied upon comparatively slow modems and thus these electronic mail messages were typically limited to short ASCII text documents. Modem electronic mail messaging systems, on the other hand, may utilize high-speed connections to transmit documents containing complex formatting, audio, graphics, video, and the like. For example, a user may send and/or receive an electronic mail messages with a PowerPoint attachment including formatted text, images, and animations. For another example, a user with the appropriate licenses may send and/or receive a feature length movie as an electronic mail message. The size of these files may easily exceed several megabytes, and users may expect to transmit even larger files in the future.

Despite the advantages of using high-speed connections to transmit large information-rich electronic mail messages, the same messages can become problematic when they must be transmitted by a lower speed connection. For example, a user reading electronic mail messages on a laptop computer connected to the Internet via a 14.4K dial-up modem may have to wait an inordinate amount of time for a large electronic mail message to be downloaded through the modem. As another example, a user writing electronic messages on the laptop computer connected to the Internet via a 14.4 KB dial-up modem may want to attach a large document to an electronic mail message, but may have to wait an unreasonable amount of time for the electronic mail message to be uploaded through the modem. In addition, bottlenecks, heavy traffic, device malfunctions, severed transmission lines, geomagnetic storms, and the like can dramatically, and often unpredictably, decrease the transfer rate of even the highest speed networks.

The content of an electronic mail message may also be subject to a variety of digital rights management rules, including copyright restrictions, distribution rights, broadcast rights, reproduction rights, publication rights, licensing restrictions, fair use, other restrictions imposed by the Digital Millennium Copyright Act, and the like. For example, a musician may create a digital representation of a musical composition in a format such as the Moving Pictures Expert Group 1 Audio Layer 3 format, commonly known as MP3. Although the musician may want to distribute the MP3 file to a wide audience, he/she may also want to be reimbursed for the creative work of composing the music. Consequently, the musician may only grant the right to use the MP3 file to listeners that have purchased digital rights, e.g. a license, to use the MP3 file. The listener, on the other hand, may not want to purchase the digital rights until he/she has previewed the composition.

The present invention is directed to addressing, or at least reducing, the effects of, one or more of the problems set forth above.

### SUMMARY OF THE INVENTION

In one aspect of the instant invention, a method of providing a portion of an electronic mail message based upon digital rights is presented. The method includes determining that a user is authorized to receive less than all of an electronic mail message, selecting a portion of the electronic mail message such that the user is authorized to receive the selected portion of the electronic mail message, and providing the selected portion of the electronic mail message. An apparatus for implementing the method, and an article comprising one or more machine-readable storage media containing instructions that when executed enable a processor to perform the method, are also presented.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a system for practicing one or more embodiments of the present invention.

FIG. 2 shows one embodiment of an e-mail that may be stored by an e-mail management module, in accordance with one embodiment of the present invention.

FIG. 3 conceptually illustrates one alternative embodiment of a system that may implement one or more embodiments of the present invention.

FIG. 4 illustrates one embodiment of a method for providing a portion of an electronic mail message based upon digital rights management rules, in accordance with one embodiment of the present invention.

FIG. 5 illustrates one embodiment of a user profile, in accordance with one embodiment of the present invention.

FIG. 6 shows one embodiment of a method for providing a portion of an electronic mail message, in accordance with one embodiment of the present invention.

FIG. 7 illustrates one embodiment of a dialog box, in accordance with one embodiment of the present invention.

FIG. 8 illustrates one embodiment of an acquisition dialog box and one embodiment of a modification dialog box, in accordance with one embodiment of the present invention.

FIG. 9 shows a stylized block diagram of a processor-based device, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e. a definition that is different from the ordinary and customary meaning as understood by those skilled in the art, is intended to be implied by consistent usage of the term or phrase herein. To the extent that a term or phrase is intended to have a special meaning, i.e. a meaning other than that understood by skilled artisans, such a special definition will be expressly set forth in the specification in a definitional manner that directly and unequivocally provides the special definition for the term or phrase.

As will be described in detail below, the present invention provides for intelligent use of the bandwidth available for transmitting electronic mail messages. For example, in one embodiment of the present invention, an e-mail server may autonomously decide whether an e-mail should be uploaded and/or downloaded based upon digital rights management rules such as copyright restrictions, distribution rights, broadcast rights, reproduction rights, publication rights, licensing restrictions, fair use, and the like. In another embodiment, a user may decide, manually or using an automated process based upon selected user preferences, what portions of an e-mail are sent and/or received to conform to the digital rights management rules. The user may also be provided with notifications of what choices are available and what actions have been taken.

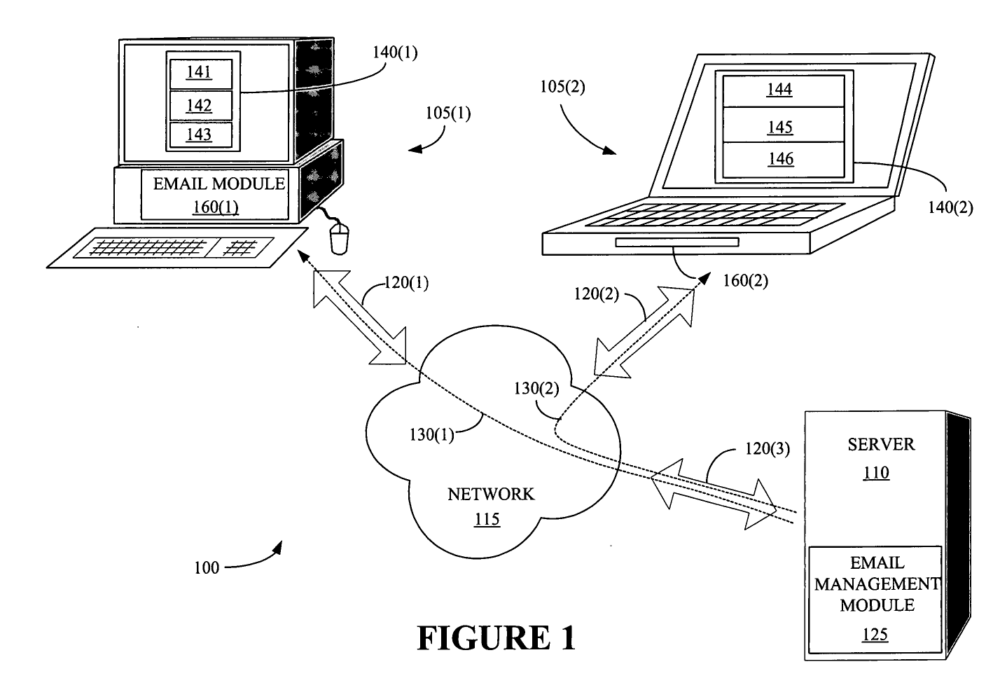

FIG. 1 illustrates a system 100 for practicing one or more embodiments of the present invention. In particular, FIG. 1 conceptually illustrates an embodiment that includes a plurality of processor-based devices 105(1-2) coupled to a server 110 by a network 115. In the illustrated embodiment, the processor-based device 105(1) is a desktop computer and the processor-based device 105(2) is a laptop computer, although in other embodiments, these processor-based devices 105(1-2) may be any desirable type of computer, personal digital assistant, cellular telephone, and the like.

The server 110, in one embodiment, may be one form of a processor-based device that can be accessed over the network 115. In accordance with one embodiment of the present invention, and as discussed below, the server 110, if desired, provides a less than the entire electronic mail message to a remote user. In one embodiment, the server 110 may be capable of performing tasks such as receiving, queuing, storing, and/or distributing e-mails to one or more users. Although not so limited, in one embodiment, one or more of the described embodiments of the present invention can be implemented within a conventional e-mail server, such as a Microsoft® Exchange Server. In the interest of clarity, the potential functionality of the server 110 not related to the present invention will not be described in further detail, as these tools and/or features are well known to persons of ordinary skill in the art.

In the embodiment illustrated in FIG. 1, the processor-based devices 105(1-2) and the server 110 are communicatively coupled to the network 115 over one or more communications links 120(1-3). In various alternative embodiments, the links 120(1-3) may be one or more of infrared links, wireless local area network (LAN) links, wired LAN connections such as Ethernet connections, cellular network links, circuit board traces, wires, cables, radiofrequency links, satellite links, and the like. Moreover, any desirable protocol may be used for communications between the processor-based devices 105(1-2) and the server 110 via the network 115. For example, a transmission control protocol/Internet protocol (TCP/IP), a user datagram protocol/Internet protocol (UDP/IP), a file transfer protocol or trivial file transfer protocol (FTP/TFTP), and the like may be used.

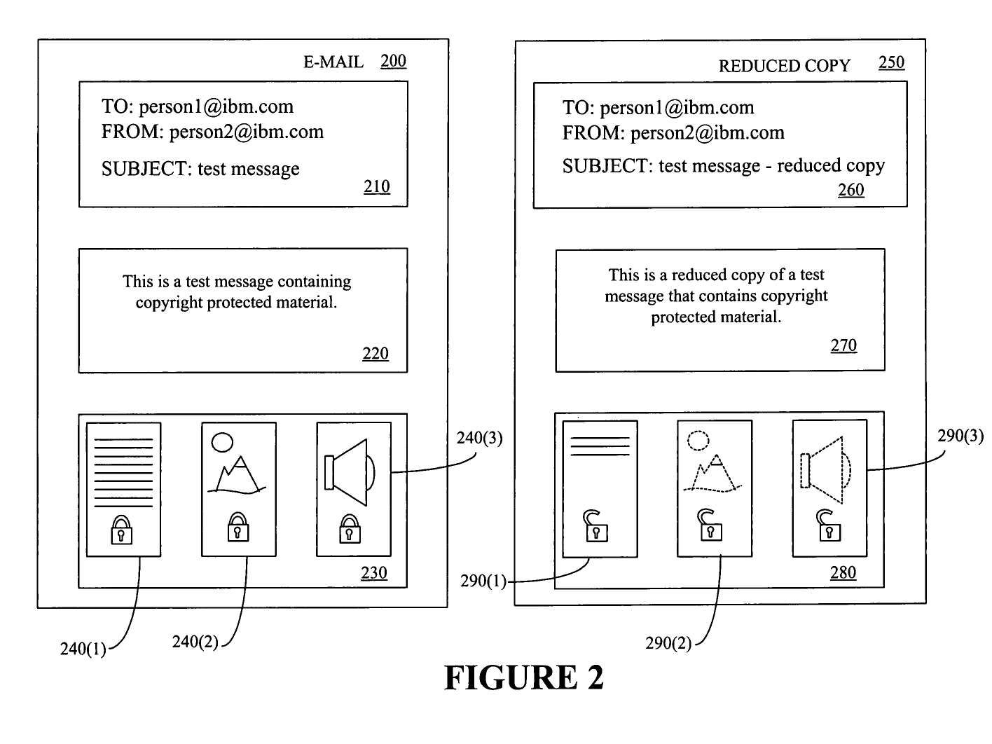

In the embodiment illustrated in FIG. 1, the server 110 includes an e-mail management module 125, which may process (e.g. receive, queue, store, and/or deliver) one or more one or more electronic mail messages, hereinafter referred to as e-mails, in accordance with common usage in the art. One form of an e-mail 200 that may be processed by the e-mail management module 125 is shown in FIG. 2. In the embodiment illustrated in FIG. 2, the e-mail 200 includes a header 210, a body 220, and one or more attachments 230. The header 210 generally includes information indicative of the recipients of the e-mail (i.e. person1@ibm.com), the sender (i.e. person2@ibm.com), and the subject of the e-mail 200 (i.e. test message). The body 220 generally includes the message being conveyed. For example, in the e-mail 200, the body includes a text string, “This is a test message containing copyright protected material.”

The e-mail message 200 shown in FIG. 2 also includes attachments 240(1-3) that, in the illustrated embodiment, include a text document 240(1), a graphics file 240(2), and an audio file 240(3). However, persons of ordinary skill in the art will appreciate that any desirable number of files, as well as any desirable type and/or format of file, may be attached to the e-mail 200. Additionally, it should be appreciated that the e-mail 200 illustrated in FIG. 2 is exemplary in nature, and that in other embodiments it may include more, fewer, or different elements. For example, the e-mail 200 may only include a header 210 and a body 220. As another example, the e-mail 200 may also include routing information that may be used to direct the e-mail 200 to a desired destination.

Portions of the e-mail message 200 may be subject to one or more digital rights management rules, as indicated by the closed padlocks shown in the attachments 240(1-3). For example, the text document 240(1) may be an original work of fiction and the copyright for the text document 240(1) may be owned by an author, a publisher, and the like. For another example, the graphics file 240(2) may be an original work of art, such as a film, a movie, an animation, a photograph, an image, an architectural rendering, and the like. The copyright, broadcast rights, reproduction rights, distribution rights, and the like may be owned by the artist, a studio, an entity that has purchased one or more of the aforementioned rights, and the like. For yet another example, the audio file 240(3) may be a musical composition, a spoken word performance, and the like, which may be owned by a composer, a musician, or other entity.

Referring back to FIG. 1, the e-mail management module 125 on the server 110 provides the e-mail 200, or a selected portion, to one or more designated recipients, which, for illustrative purposes, are assumed to be the users of the processor-based systems 105(1-2). Thus, in this illustrative example, the e-mail management module 125 provides at least the selected portion of the e-mail 200 to the processor-based devices 105(1-2). However, persons skilled in the art will appreciate that, in alternative embodiments, any number of users of any desirable processor-based systems may be designated as the recipients and may receive portions of the e-mail 200 provided by the e-mail management module 125. The portion of the e-mail 200 transmitted to the user of each processor-based device 105(1) and 105(2) is hereinafter designated in FIG. 1 by reference numbers 140(1) and 140(2), respectively.

The e-mail management module 125 may provide the e-mail 200 via a variety of communication paths 130(1-2). In the illustrated embodiment, the e-mail management module 125 may transmit a selected portion of the e-mail 200 (designated by reference number 140(1)) to the processor-based device 105(1) along the communication path 130(1), which may include the link 120(3), the network 115, and the link 120(1). The e-mail management module 125 may also transmit a selected portion of the e-mail 200 (designated by reference number 140(2)) to the processor-based device 105(2) along the communication path 130(2), which may include the link 120(3), the network 115, and the link 120(2). Those skilled in the art will appreciate that communications paths 130(1-2) may include one or more intermediate gateways (not shown), routers (not shown), and the like.

Depending upon the applicable digital rights, one or more intended recipients of the e-mail message 200 may not be authorized to receive portions of the e-mail message 200 such as the attachments 240(1-3). In order to protect the digital rights that may be associated with various portions of the e-mail message 200 and also provide some information indicative of the protected content of the e-mail 200, the e-mail management module 125, in one embodiment, may only transfer a portion of the e-mail 200 along one or more of the communication paths 130(1-2). As will be discussed in detail below, the e-mail management module 125, in one embodiment, may determine that a portion of the protected e-mail message 200 may be provided without violating the associated digital rights management rules. The e-mail management module 125 may then select the portion of the e-mail that is determined to not violate the associated digital rights management rules and provide the selected portion.

FIG. 2 shows one embodiment of a reduced copy 250, which includes a header 260 and a body 270. The header 260 includes information indicative of the recipients of the e-mail (i.e. person1@ibm.com), the sender (i.e. person2@ibm.com), and the subject of the e-mail 200 (i.e. test message—reduced copy). The body 270 includes a text string, “This is a test message that does not contain copyright protected material.” The reduced copy 250 may also include an unprotected portion 280 that may include attachments 290(1-3) that are determined not to violate the digital rights management rules associated with the attachments 240(1-3), as indicated by the open padlocks in the attachments 290(1-3). For example, the e-mail management module 125 may determine that a section 290(1) of the text document 240(1), a thumbnail 290(2) of the graphics attachment 240(2), a reduced resolution clip 290(3) of the audio attachment 240(3), and the like may be provided without violating the digital rights management rules associate with the attachments 240(1-3).

The attachments 240(1-3) may be created using any of a variety of tools. For example, the text document 240(1) may be created using Microsoft Word®, Acrobat Distiller®, Power Point®, Lotus WordPro®, or another document creation or publication tool. Thus, the e-mail management module 125 may determine a format of the e-mail 200 and/or the attachments 240(1-3), and then provide a selected portion of the e-mail 200 and/or the attachments 240(1-3), such as the attachments 290(1-3) that are determined to not violate the associated digital rights management rules, based upon the determined format. For example, the e-mail management module 125 may identify at least one chart, table, page, agenda, table of contents, summary, audio clip, or video clip based upon the determined format.

Moreover, the graphics file 240(2) and/or the audio file 240(3) may be formed in various proprietary and non-proprietary formats including, but not limited to, one of the Moving Picture Experts Group (MPEG) formats, a Joint Photographic Experts Group (JPEG) format, Graphics Interchange Format (GIF) format, Portable Network Graphics (PNG) format, Video for Windows® format, AVI format, and Apple Quicktime® format. Thus, the e-mail management module 125 may determine a format of at least a portion of the e-mail 200 (including the attachments 240(1-3)), select a portion of the e-mail 200 to transmit and downcast the selected portion of the e-mail 200. In one embodiment, the e-mail management module 125 may select portions of an audio file, video file, a multimedia file, an image file, a graphics file, and the like to form the attachments 290(1-3) that are determined to not violate the associated digital rights management rules. In one alternative embodiment, the e-mail management module 125 may downcast one or more attachments 240(1-3), i.e. the e-mail management module 125 may provide reduced resolution portions of an audio file, a video file, an image file, a multimedia file, a graphics file, and the like to form the attachments 290(1-3) that are determined to not violate the associated digital rights management rules.

Furthermore, the data transfer rate along the communication paths 130(1-2) may vary by many orders of magnitude. For example, the communication path 130(1) may consist of a dedicated T-3 connection that may provide data at a transfer rate as high as 40 megabits per second. Accordingly, even if the attachments 240(1-3), 290(1-3) attached to the e-mail 200, 330 are large, e.g. 100 MB, the total time required to transfer the copy 140(1) may remain comparatively low, e.g. a few seconds in the case of the 100 MB attachments 240(1-3), 290(1-3). In contrast, the communication path 130(2) may include a dial-up connection, such as the link 120(2), which may transfer data at a much lower rate. Thus, a user may have to wait several hours for the 100 MB attachments 240(1-3), 290(1-3) to be transferred via the communication path 130(2). The long transfer time may inconvenience the user, particularly if the user does not wish to see the attachments 240(1-3), 290(1-3) but does want to see one or more e-mails that may be transferred subsequently from the server 110.

Thus, in order to reduce the potential inconvenience to the user and increase the efficiency of the system 100, the e-mail management module 125 may, in one embodiment, also select a portion of the e-mail message 200 based upon other criteria such as a data transfer rate, a size of the e-mail 200, and the like. In one embodiment, this selection process may happen concurrently with the aforementioned selection process based upon the digital rights management rules. However, persons of ordinary skill in the art will appreciate that, in alternative embodiments, selecting a portion of the e-mail message 200 based upon other criteria such as a data transfer rate, a size of the e-mail 200, and the like may occur as a part of a separate process that takes place before, during, or after the aforementioned selection process based upon the digital rights management rules.

In one embodiment, the e-mail management module 125 may select the portion of the e-mail message 200 to be transferred along one or more of the communication paths 130(1-2) by estimating a data transfer rate for the communication paths 130(1-2) and a size of the e-mail 200. In one embodiment, the estimated data transfer rate and the estimated size of the e-mail 200 may be used to estimate the time required to transfer the e-mail 200 along the communication paths 130(1-2). The e-mail management module 125 may also determine a threshold time, such as a user's maximum preferred time to transfer the e-mail 200, and compare the determined threshold to the estimated e-mail transfer time. For example, the user may select a maximum preferred transfer time of approximately one minute. For another example, the user may select a maximum preferred transfer time of approximately zero minutes to force the e-mail management module to provide a reduced copy 140(2) of all e-mails 200. Alternatively, the threshold time may be a default time.

If the estimated e-mail transfer time is substantially less than the predetermined threshold time, the e-mail management module 125 may transmit substantially all of the e-mail 200. For example, the processor-based device 105(1) may receive the complete copy 140(1) of the e-mail message 200, including a header 141, a body 142, and one or more attachments 143. However, if the estimated e-mail transfer time is substantially more than the predetermined threshold time, and it is not desirable to transmit the entire e-mail 200, the e-mail management module 125 may transmit a portion of the e-mail 200. For example, the processor-based device 105(2) may receive the reduced copy 140(2) of the e-mail message 200, including a header 144, a body 145, and one or more attachments 146, such as the attachments 290(1-3) shown in FIG. 2.

Although the e-mail management module 125 may provide the e-mail 140(1-2) in a single session, the e-mail management module 125 may also, in alternative embodiments, “trickle download” the e-mail 140(1-2), i.e. successively download portions of the e-mail 140(1-2) in the background during one or more sessions, to the processor-based device 105(2). In one embodiment, the e-mail management module 125 may notify the user to indicate what choices are available, e.g. downloading the reduced copy 140(2) or trickle downloading the e-mail 140(1), and/or what actions have taken place.

The e-mail management module 125 may queue and/or store the e-mail 200. In one embodiment, the e-mail management module 125 may store the e-mail 200 until the intended recipient demonstrates that the appropriate digital rights have been obtained. For example, if the unprotected reduced copy 140(2) has been transmitted to the processor-based device 105(2), the e-mail 200 may be queued and/or stored and the intended recipient may be prompted to purchase or enact a license to receive the protected portions of the e-mail 200. In one embodiment, the e-mail management module 125 may periodically provide reminders, such as a pop-up dialog box, asking the user to acquire the appropriate digital rights and/or asking if the user would like to download the e-mail 200. Alternatively, the e-mail management module 125 may direct the intended recipient to a web site where the appropriate digital rights may be obtained.

In one embodiment, the processor-based devices 105(1-2) may include e-mail modules 160(1-2), which may carry out a portion of the aforementioned processes or additional processes. For example, the e-mail modules 160(1-2) may allow a user to set up preferences as to how electronic mail messages are to be handled. For example, the user may set up a profile containing information indicative of the digital rights currently acquired by the user. In various alternative embodiments, the profile, or other indications of the digital rights acquired by the user, may be stored locally or on a remote device. When the user is ready to process electronic mail messages, the e-mail modules 160(1-2) may send a message to the server 110, such as a POP3 or IMAP server 110, which may cause various flags to be set based upon the user preferences. Electronic mail messages may then be processed in accordance with the user preferences indicated by the flags, as will be discussed in detail below. The modules 125, 160(1-2) illustrated in FIG. 1 are implemented in software, although in other implementations the modules 125, 160(1-2) may also be implemented in hardware or a combination of hardware and software.

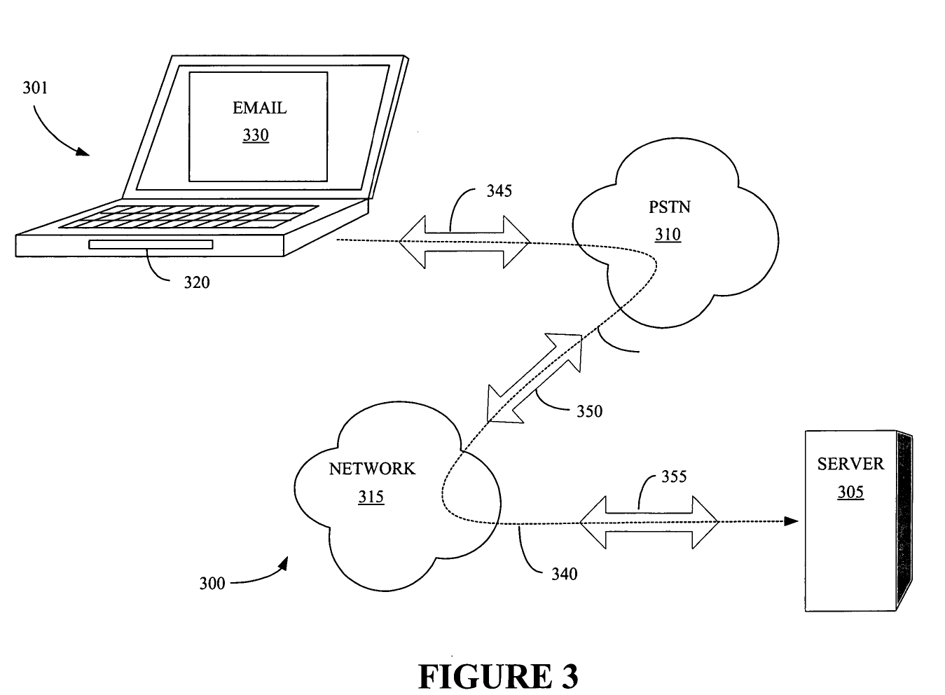

FIG. 3 conceptually illustrates a system 300 that may implement one or more alternative embodiments of the present invention. In FIG. 3, a processor-based device 301 is communicatively coupled to a server 305 by a public switched telephone network (PSTN) 310 and a network 315. Thus, the transmission of e-mails from the processor-based device 301 to the server 305 may be implemented in the alternative embodiment shown in FIG. 3. In the illustrated embodiment, the processor-based device 301 includes an e-mail management module 320 that may provide a copy of an e-mail 330 to the server 305. For example, in the illustrated embodiment, the e-mail management module 320 may transmit at least a portion of the e-mail 330 that is not copyright-restricted to the server 310 along the communication path 340, which may include the link 345, the public switched telephone network 310, the link 350, the network 315, and the link 355.

In one embodiment, after transmitting the copyright-unrestricted portion of the e-mail 330 along the communication path 340, the e-mail management module 320 may queue and/or store the e-mail 330 until the e-mail management module 320 receives an indication that the intended recipient has acquired the appropriate digital rights. For example, the intended recipient may purchase or enact a license from a third-party vendor and then provide an indication of the newly acquired license to the e-mail management module 320, which may then provide the queued and/or stored e-mail containing protected content. Alternatively, the intended recipient may be an automated e-mail distributor, which may acquire digital distribution rights. Moreover, in alternative embodiments, a user with the appropriate authorization may modify the digital rights associated with the e-mail 330.

As discussed above, the data transfer rate along the communication path 340 may vary by many orders of magnitude. For example, if the processor-based device 301 is linked to the public switched telephone network (PSTN) 310 via a 14.4 KB modem (not shown), it may not be desirable to transmit a 100 MB attachment (not shown) to the server 305. Thus, the e-mail management module 320 may only transmit a portion of the e-mail 330 along the communication path 340. Alternatively, the e-mail 330 may be trickle uploaded to the server 305 along the communication path 340.

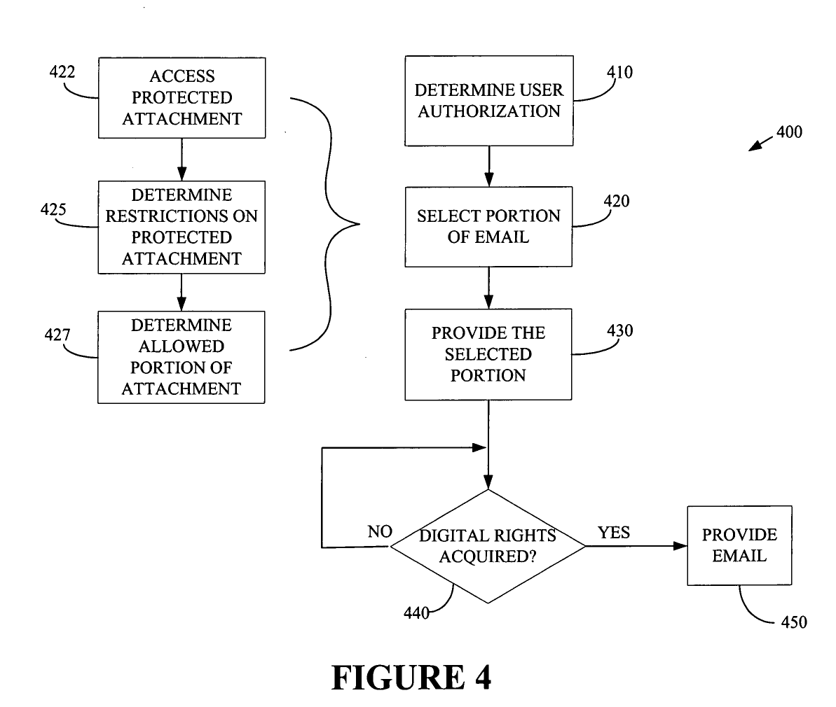

FIG. 4 illustrates one embodiment of a method 400 for providing a portion of an electronic mail message based upon digital rights management rules. In one embodiment, an e-mail management module, such as the e-mail management modules 125, 320 and/or the e-mail modules 160(1-2) shown in FIGS. 1 and 3, determines (at 410) that a user is authorized to receive less than all of the electronic mail message. As discussed in detail above, the e-mail management module 125 or 320 may determine (at 410) the user authorization based on a variety of digital rights management rules including, but not limited to, rules governing copyright, distribution, broadcast, reproduction, publication, licensing, and fair use. For example, the e-mail management module 125 or 320 may determine (at 410) that, based on the digital rights management rules, the user is not authorized to receive one or more attachments, such as the attachments 240(1-3).

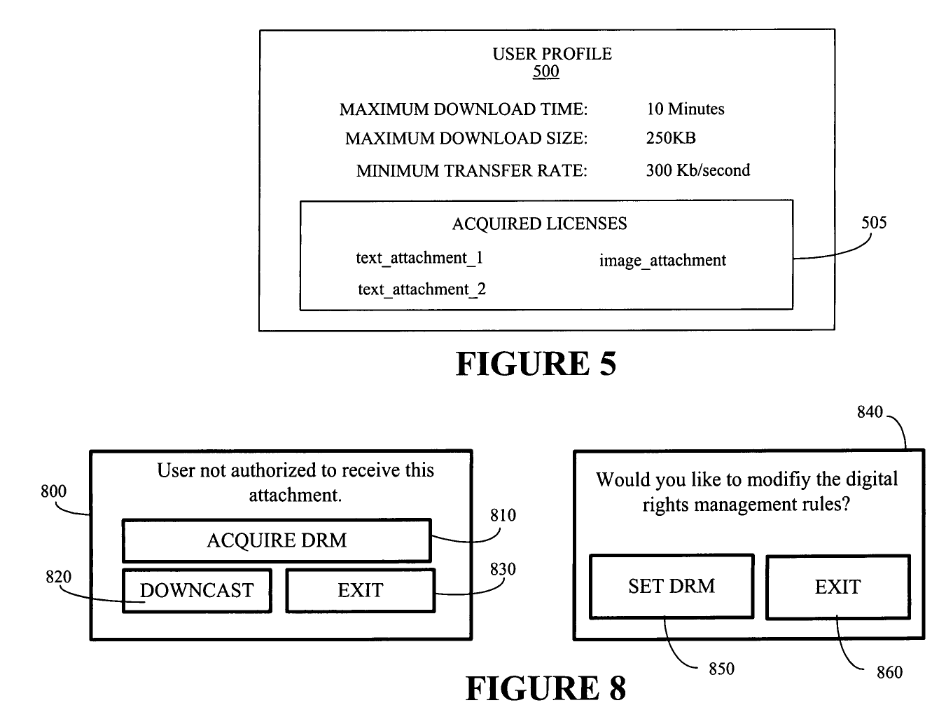

In one embodiment, illustrated in FIG. 5, a user may provide a user profile 500 indicating the digital rights associated with the user. For example, the user profile 500 may include an acquired license list 505. The acquired license list 505 may include names of the files that are licensed to the user, as well as any other information indicative of the digital rights of the user. For example, the acquired license list may also include a number of times the files may be reproduced and/or distributed, in what media the files may be reproduced and/or distributed, the resolution allowed in versions distributed to non-licensees, whether the user is authorized to modify the digital rights management rules that apply to the file, and the like. In one embodiment, some or all of the information stored in the user profile 500 may be manually provided by the user when the user connects to access the stored e-mails, or, alternatively, the information, if pre-stored, may be made available to a device (e.g. the server 110) desiring access to the stored information.

Some or all of the information stored in the user profile 500 may be modified. For example, new licenses may be added to the acquired license list 505 as the new licenses are acquired. Depending on the implementation, the user profile 500 may be pre-stored at any desirable location, including the processor-based devices 105(1-2), 301, the servers 110, 305, and the like. For illustrative purposes, it is assumed that the user profile 500 is stored in a convenient location, and, if desired, can be accessed by the appropriate device and/or module, including the e-mail modules 160(1-2), 320, the e-mail management module 125, and the like.

The e-mail management module 125 or 320 selects (at 420) a portion of the electronic mail message such that the user is authorized to receive the selected portion. In one embodiment, the e-mail management module 125 or 320 may select (at 420) the portion of the electronic mail message by accessing (at 422) one or more protected attachments to the electronic mail message. For example, the e-mail management module 125 or 320 may access (at 422) the protected audio attachment 240(3). The e-mail management module 125 or 320 may then determine (at 425) one or more restrictions imposed on the protected attachments. For example, the e-mail management module may determine (at 425) that no more than 30 seconds of the protected audio attachment 240(3) may be provided to an unauthorized user. The e-mail management module 125 or 320 may then select (at 427) the portion of the protected attachment based upon the determined restrictions. For example, the e-mail management module 125 or 320 may select a 30-second-long clip of the protected audio attachment 240(3). In alternative embodiments, the e-mail management module 125 or 320 may select (at 427) other portions of the protected attachment based upon the determined restrictions including, but not limited to, lower resolution versions of the attachment, lossy versions of the attachment, and versions that may be viewed and/or distributed by e-mail but not printed, copied, or forwarded.

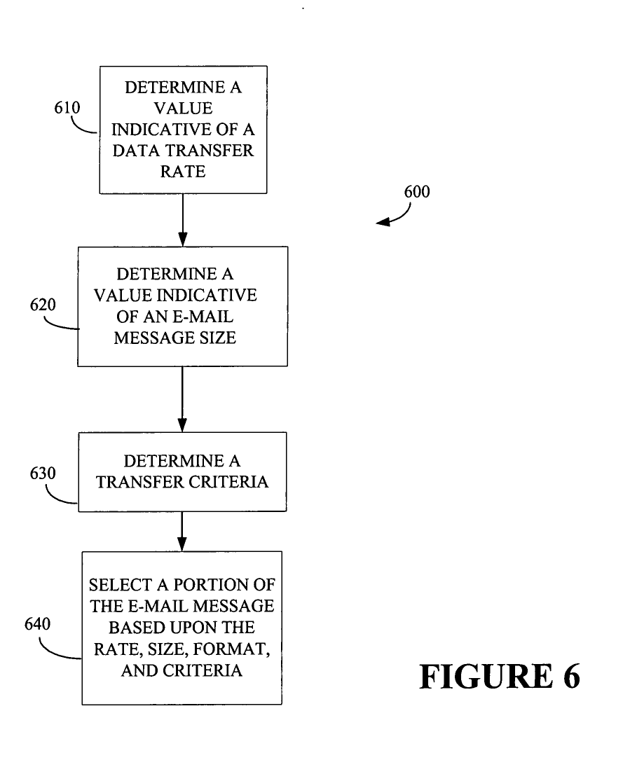

As discussed above, the e-mail management module 125 or 320 may also select (at 420) a portion of the electronic mail message based upon other criteria such as a data transfer rate, a size of the e-mail 200, and the like. FIG. 6 illustrates one embodiment of the method of 600 for selecting (at 420) a portion of the electronic mail message based upon a data transfer rate, a size of the electronic mail message, and a threshold time. In the illustrated embodiment, a value indicative of, or associated with, a data transfer rate is determined (at 610). For example, an e-mail management module, such as the e-mail management modules 125, 320 and/or the e-mail modules 160(1-2), may determine (at 610) an average data transfer rate using one or more data packets received within a time period. Alternatively, the e-mail management module 125 or 320 may determine (at 610) a data transfer rate using a device profile. For example, the e-mail management module 125 or 320 may determine (at 610) that a 14.4 KB modem is being used to transmit data and, thus, the e-mail management module 125 or 320 may determine (at 610) that the data transfer rate may not exceed approximately 14.4 KB. Persons of ordinary skill in the art should appreciate that the aforementioned techniques for determining (at 610) the data transfer rate are exemplary and not intended to limit the present invention.

A value indicative of, or associated with, a size of an electronic mail message is also determined (at 620). In one embodiment, the e-mail management module 125 or 320 may determine (at 620) the size of the electronic mail message by determining (at 620) the number of bits in the electronic mail message. Alternatively, the size of the electronic mail message may be determined (at 620) using information that may be transmitted with the electronic mail message.

A mail transfer criteria is also determined (at 630). In the previously discussed embodiments of the present invention, the mail transfer criteria has been associated with a mail transfer threshold time, such as a user's preferred maximum transfer time or a default threshold time. In these embodiments, the mail transfer criteria is determined (at 630) by determining the threshold time using an indication of the user's preferred maximum transfer time, such as a user profile, or an indication of the default threshold time. However, the potential mail transfer criteria are not limited to the threshold time. In alternative embodiments, the mail transfer criteria may include various user preferences such as a maximum size of an attachment, a minimum average data transfer rate, a time of day, and the like.

Referring back to FIG. 5, in one embodiment, a user may indicate, via the user profile 500, one or more user preferences that may be used to determine (at 630) the mail transfer criteria. For example, the user may indicate, via the user profile 500, that e-mails that can be downloaded within a preselected time (e.g. in 10 minutes or less) should be downloaded. Alternatively, the user profile 500 may indicate that e-mails smaller than a preselected size (e.g. about 250 KB or less) should be downloaded and/or that e-mails that can be downloaded at an average rate of greater than a preselected threshold (e.g. about 300 Kbps) should be downloaded. However, persons of ordinary skill in the art should appreciate that any other desirable criteria, such as a priority level and the like, may be provided in the user profile 500 and may be used to determine (at 630) the mail transfer criteria.

In one embodiment, when the user is ready to process one or more of the received e-mails, a message indicative of the information included in the user profile 500 may be sent to a server, such as the servers 110, 305, which may set flags based upon the user preferences. For example, the flags may indicate that the server 110, 305 should queue and hold e-mails that are to be sent and/or received via a high speed connection, should not download attachments larger that the Maximum Download Size indicated in the user profile 500, should prompt before uploading and/or downloading attachments, should download only files with the necessary licenses, and the like.

In some embodiments, flags may also be set on the processor-based-devices 105(1-2), 301 and other devices (not shown) such as third-party proxy servers, e.g. mail servers, and the like. However, persons of ordinary skill in the art should appreciate that the other devices, such as proxy servers, may have additional rules for handling e-mails. For example, a mail server may operate according to a rule that limits the size and/or number of copies of an e-mail that may be sent. The device rules may, in some instances, override the preferences and/or flags that may be determined according to some embodiments of the present invention. For example, the mail server may decline to send copies of a 50 MB e-mail to 100 users, regardless of the preferences that may be indicated by the user profile 500 and/or the flags that may be set on the processor-based-devices 105(1-2), 301 and other devices.

Referring back to FIG. 6, a portion of the electronic mail message is then selected (at 640) based upon the determined data transfer rate, the determined size of the electronic message, and the mail transfer criteria. In one embodiment, the determined data transfer rate and the determined size of the electronic mail message may be used to estimate the total transfer time for the electronic message. The estimated transfer time may then be compared to the threshold time and, if the estimated transfer time does not exceed the threshold time, substantially all of the electronic mail message may be selected (at 640). However, if the estimated transfer time substantially exceeds the threshold time, a portion of the electronic mail message may be selected (at 640). In one embodiment, the e-mail management module may also provide the user with an option to select (at 640) the portion of the electronic mail message.

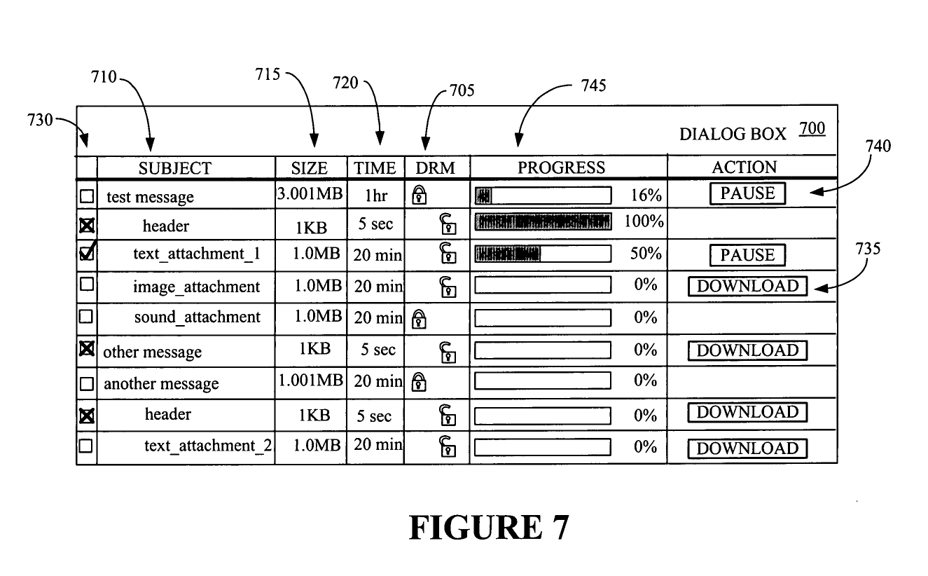

In one embodiment, illustrated in FIG. 7, a dialog box 700 may be displayed to the user. However, persons of ordinary skill in the art will appreciate that the present invention is not limited to the dialog box 700. In alternative embodiments, any desirable type of user interface, including a graphical user interface or display, may be displayed to the user in order to provide information to, and/or receive information from, the user. The dialog box 700 may display a list of the e-mails and information associated with the e-mails. For example, as shown in FIG. 7, one entry (indicated by the phrase “test message” in subject field 710) has a size field 715 that indicates that the size of the e-mail is approximately 3.001 MB and a download time field 720 that indicates that the entire e-mail may take approximately one hour to download at the current connection speed. Various portions and/or attachments may also be displayed in the dialog box 700. For example, the size field 715 indicates that the size of the header is approximately 1 KB and the download time field 720 indicates that the header may take approximately 5 seconds to download at the current connection speed. For another example, the size field 715 indicates that the size of the text_attachment is approximately 1.0 MB and the download time field 720 indicates that the text_attachment may take approximately 20 minutes to download at the current connection speed.

The e-mails, portions thereof, and/or attachments displayed in the dialog box 700 may be determined in a variety of ways. In one embodiment, a user may determine the e-mails, portions, and/or attachments displayed in the dialog box 700. For example, a user may create an e-mail including one or more tags that indicate which e-mail portions and/or attachments should be displayed in the dialog box 700. For another example, a user may highlight a portion of the e-mail by clicking-and-dragging over the desired portion of the e-mail using a controllable pointer element, e.g. a mouse, a joystick, and the like. The user may then indicate that the highlighted portion should be displayed in the dialog box 700 by, for example, selecting an option from a drop-down menu using the controllable pointer element. The e-mail management module may then determine displayable information associated with the e-mails including, but not limited to, the size and estimated download time of the e-mail portions and/or attachments. However, persons of ordinary skill in the art should appreciate that the present invention is not limited to embodiments wherein the user determines the portions and/or attachments displayed in the dialog box 700. In alternative embodiments, the e-mail management module may determine the portions and/or attachments displayed in the dialog box 700. For example, the e-mail management module may determine the portions and/or attachments displayed in the dialog box 700 using information such as the user profile, the device profile, the file size, the connection speed, the estimated download time, and the like.

In one embodiment, the e-mail management module may select (at 640) portions of the e-mails to be downloaded. For example, based upon the user profile 500, the e-mail management module may select (at 640) the “header” of the “test message,” the “other message,” and the “header” of the “another message,” as indicated by the X-marks in selection field 730. Alternatively, the user may select (at 640) portions of the e-mail to be downloaded. For example, the user may control a pointer element on the graphical user display with a pointer controller having position and selection status responsive to operation by the user, such as a mouse, a joystick, and the like, to select (at 640) the text_attachment. For example, the user may use a mouse to click the box in the selection field, thereby selecting (at 640) the text_attachment, as indicated by the check-mark in the selection field 730. However, if the user selects (at 640) a protected attachment, the e-mail management module may override the user selection, or opt to provide only a reduced resolution version, as discussed above.

Referring back to FIG. 4, the selected portion of the electronic mail message is provided (at 430) to, for example, a processor-based device and/or a server, as discussed in detail above. In one embodiment, the electronic mail message is queued and/or stored, e.g. on a client or on a server, after the selected portion of the electronic mail message is provided (at 430). In one embodiment, a user may create the electronic mail message on a processor-based device and the electronic mail message may remain queued and/or stored on the processor-based device. Alternatively, the electronic mail message may remain queued and/or stored on a server. As discussed above, one or more notifications, such a pop-up dialog box and the like, may be provided to the user indicating that the electronic mail message is queued and/or stored.

The electronic mail message may remain queued until the e-mail management module 125 or 320 determines (at 440) that the intended recipient of the electronic mail message has acquired the appropriate digital rights. In one embodiment, the user may initiate the process of acquiring the appropriate digital rights by selecting a closed-lock icon associated with the protected file, such as the closed-lock icons shown in the DRM field 705 in FIG. 7. The user may select the closed-lock icon using, for example, a mouse, a joystick, and the like. In response to the user clicking on the closed-lock icon, an acquisition dialog box 800, such as the exemplary embodiment shown in FIG. 8, may be displayed to the user. The acquisition dialog box 800 may include an action button 810 that may direct the intended recipient to a web site where the intended recipient may acquire the appropriate digital rights for the associated attachment by, e.g. purchasing a license, an action button 820 that may provide a downcast version of the attachment, an action button 830 that may allow the user to exit the acquisition process, and the like.

In one alternative embodiment, the user may modify one or more digital rights management rules associated with the portion of the electronic mail message. For example, the user could addend digital rights management rules to a file that did not previously have an associated digital rights management rule. In one embodiment, the user may modify one or more digital rights management rules by selecting an icon associated with the portion of the electronic mail message, such as the closed-lock or open-lock icons shown in the DRM field 705 in FIG. 7. The user may select the appropriate icon using, for example, a mouse, a joystick, and the like. In response to the user clicking on the icon, a dialog box 840, such as the exemplary embodiment shown in FIG. 8, may be displayed to the user. The dialog box 840 may include an action button 850 that may allow an appropriately authorized user to modify the digital rights management rules for the associated attachment and an action button 860 that may allow the user to exit the process, and the like.

When the e-mail management module 125 or 320 determines (at 440) that the intended recipient of the electronic mail message has acquired the appropriate digital rights, the e-mail management module 125 or 320 may provide (at 450) the electronic mail message. If the e-mail management module 125 or 320 determines (at 440) that the intended recipient has not acquired the appropriate digital rights, the e-mail management module 125 or 320 may wait to provide (at 450) the electronic mail message until it determines that the intended recipient has acquired the appropriate digital rights. In one embodiment, the e-mail management module 125 or 320 may also provide (at 450) the electronic mail message based upon other mail transfer criteria such as the aforementioned data transfer rate, size of the electronic message, estimated transfer time, threshold time, and the like.

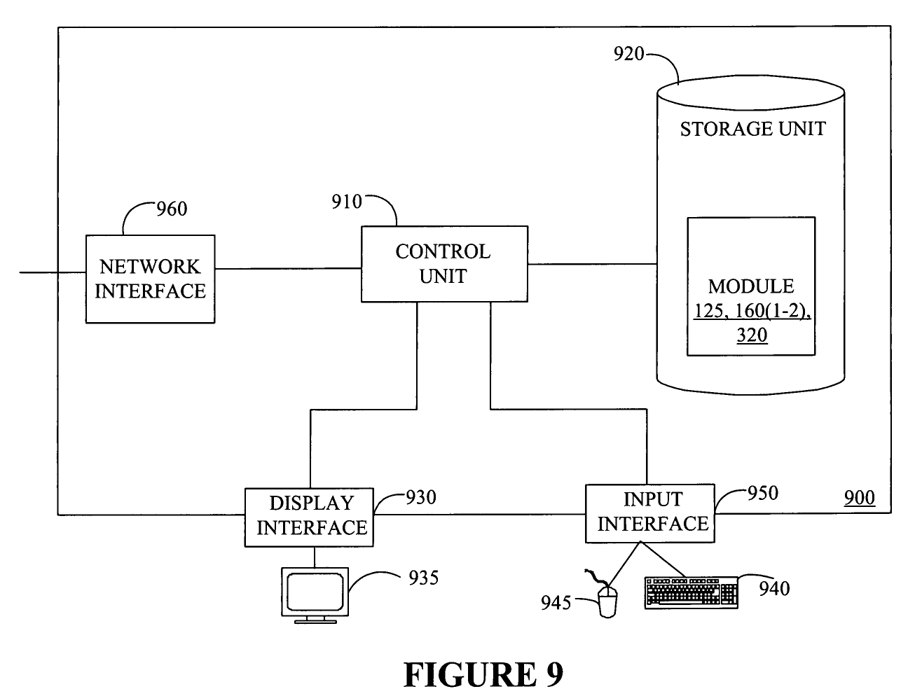

FIG. 9 shows a stylized block diagram of a processor-based device 900, in accordance with one embodiment of the present invention. In one embodiment, the processor-based device 900 may represent portions of the processor-based devices 105(1-2), 301 and/or the servers 110, 305. The device 900, depending on the particular implementation, is configured with the appropriate software configuration, including the e-mail management module 125 or the e-mail modules 160(1-2) of FIG. 1, or with the e-mail management module 320 in the system 300 of FIG. 3.

The device 900 comprises a control unit 910, which in one embodiment may be a processor that is communicatively coupled to a storage unit 920. The software installed in the storage unit 920 may depend on the features to be performed by the device 900. For example, if the device 900 represents one of the processor-based devices 105(1-2), 110, 301, 305 then the storage unit 920 may include the e-mail management modules 125, 320, as well as the e-mail modules 160(1-2). The e-mail management modules 125, 320 and the e-mail modules 160(1-2) may be executable by the control unit 910. Although not shown, it should be appreciated that in one embodiment an operating system, such as Windows®, Disk Operating System®, Unix®, OS/2®, Linux®, MAC OS®, or the like, may be stored on the storage unit 920 and be executable by the control unit 910. The storage unit 920 may also include device drivers for the various hardware components of the device 900.

In the illustrated embodiment, the device 900 includes a display interface 930. The device 900 may display information on a display device 935 via the display interface 930. In the illustrated embodiment, a user may input information using an input device, such as a keyboard 940 and/or a mouse 945, through an input interface 950. The control unit 910 is coupled to a network interface 960, which may be adapted to receive, for example, a local area network card. In an alternative embodiment, the network interface 960 may be a Universal Serial Bus interface or an interface for wireless communications. The device 900 communicates with other devices through the network interface 960. Although not shown, associated with the network interface 960 may be a network protocol stack, with one example being a UDP/IP or a TCP/IP stack. In one embodiment, both inbound and outbound packets may be passed through the network interface 960 and the network protocol stack.

It should be appreciated that the block diagram of the device 900 of FIG. 9 is exemplary in nature and that in alternative embodiments, additional, fewer, or different components may be employed without deviating from the spirit and scope of the instant invention. For example, if the device 900 is a computer, it may include additional components such as a system bus or an I/O bus. In other embodiments, the various elements of the device 900 may be interconnected using various buses and controllers. Similarly, depending on the implementation, the device 900 may be constructed with other desirable variations without deviating from the spirit and scope of the present invention.

The various system layers, routines, or modules may be executable on control units, such as the control unit 910. The control unit 910 may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit 910 cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method, comprising:
determining that a user is authorized to receive less than all of an electronic mail message based on at least one digital right associated with the electronic mail message;
selecting a portion of the electronic mail message that the user is authorized to receive; and
providing the selected portion of the electronic mail message.

2. The method of claim 1, wherein determining that a user is authorized to receive less than all of the electronic mail message comprises determining that a user is authorized to receive less than all of the electronic mail message based upon at least one of a copyright, a distribution right, a broadcast right, a reproduction right, a publication right, a licensing restriction, fair use, and a restriction imposed by the Digital Rights Millennium Copyright Act.

3. The method of claim 1, wherein determining that the user is authorized to receive less than all of the electronic mail message comprises accessing at least one of a user input and a user profile.

4. The method of claim 3, wherein accessing the user profile comprises accessing the user profile on at least one of a local device and a remote device.

5. The method of claim 1, further comprising acquiring authorization to receive a protected portion of the electronic mail message.

6. The method of claim 5, wherein acquiring the authorization comprises acquiring a license to receive the protected portion of the electronic mail message.

7. The method of claim 5, wherein acquiring the authorization comprises directing the user to an owner of the digital rights to the protected portion of the electronic mail message.

8. The method of claim 5, further comprising providing the protected portion of the electronic mail message in response to acquiring the authorization.

9. The method of claim 1, wherein selecting the portion comprises determining a format of at least one file associated with the electronic mail message.

10. The method of claim 9, wherein selecting the portion of the electronic mail message comprises identifying at least one chart, table, page, agenda, table of contents, summary, audio clip, or video clip based upon the determined file format.

11. The method of claim 9, wherein selecting the portion of the electronic mail message comprises reducing the resolution of the at least one file associated with the electronic mail message based upon the determined file format.

12. The method of claim 11, wherein reducing the resolution of the at least one file comprises downcasting a portion of at least one of an audio file, video file, a multimedia file, an image file, and a graphics file.

13. The method of claim 1, further comprising determining that it is desirable to receive less than all of the electronic mail message.

14. The method of claim 13, wherein determining that it is desirable to provide less than all of an electronic mail messages comprises:
determining a threshold time;
determining a value associated with a data transfer rate;
determining a value associated with a size of the electronic mail message;
estimating a transfer time using the determined value associated with the data transfer rate and the determined value associated with the size of the electronic mail message;
comparing the threshold time and the estimated transfer time; and
selecting a portion of the electronic mail message based upon the comparison.

15. The method of claim 1, wherein providing the selected portion of the electronic mail message comprises transmitting the selected portion from a server to a processor based device and storing the electronic mail message on the server.

16. The method of claim 1, wherein providing the selected portion of the electronic mail message comprises transmitting the selected portion from a processor-based device to a server and storing the electronic mail message on the processor based device.

17. An article comprising one or more machine-readable storage media containing instructions that when executed enable a processor to:
determine that a user is authorized to receive less than all of an electronic mail message based on at least one digital right associated with the electronic mail message;
select a portion of the electronic mail message that the user is authorized to receive; and
provide the selected portion of the electronic mail message.

18. The article of claim 17, wherein the one or more machine-readable storage media contain instructions that when executed enable the processor to access at least one of a user input and a user profile.

19. The article of claim 17, wherein the one or more machine-readable storage media contain instructions that when executed enable the processor to acquire authorization to receive a protected portion of the electronic mail message.

20. The article of claim 19, wherein the one or more machine-readable storage media contain instructions that when executed enable the processor to provide the protected portion of the electronic mail message in response to acquiring the authorization to receive the protected portion of the electronic mail message.

21. The article of claim 19, wherein the one or more machine-readable storage media contain instructions that when executed enable the processor to direct the user to an owner of the digital rights to the unauthorized portion of the electronic mail message.

22. The article of claim 17, wherein the one or more machine-readable storage media contain instructions that when executed enable the processor to downcast a portion of at least one of an audio file, video file, a multimedia file, an image file, and a graphics file.

23. The article of claim 17, wherein the one or more machine-readable storage media contain instructions that when executed enable the processor to:
determine a threshold time;
determine a value associated with a data transfer rate;
determine a value associated with a size of the electronic mail message;
estimate a transfer time using the determined value associated with the data transfer rate and the determined value associated with the size of the electronic mail message;
compare the threshold time and the estimated transfer time; and
select a portion of the electronic mail message based upon the comparison.

24. An apparatus, comprising:
an interface; and
a control unit coupled to the interface and adapted to:
determine that a user is authorized to receive less than all of an electronic mail message based on at least one digital right associated with the electronic mail message;
select a portion of the electronic mail message that the user is authorized to receive; and
provide the selected portion of the electronic mail message.

25. The apparatus of claim 24, wherein the control unit is adapted to access at least one of a user input and a user profile via the interface.

26. The apparatus of claim 24, wherein the control unit is adapted to acquire authorization to receive a protected portion of the electronic mail message.

27. The apparatus of claim 26, wherein the control unit is adapted to provide the protected portion of the electronic mail message in response to acquiring the authorization to receive the protected portion of the electronic mail message.

28. The apparatus of claim 24, wherein the control unit is adapted to downcast a portion of at least one of an audio file, video file, a multimedia file, an image file, and a graphics file.

29. The apparatus of claim 24, wherein the control unit is adapted to:
determine a threshold time;
determine a value associated with a data transfer rate;
determine a value associated with a size of the electronic mail message;
estimate a transfer time using the determined value associated with the data transfer rate and the determined value associated with the size of the electronic mail message;
compare the threshold time and the estimated transfer time; and
select a portion of the electronic mail message based upon the comparison.

30. A system, comprising:
a first processor based device; and
a second processor based device adapted to:
determine that a user of the first processor based device is authorized to receive less than all of an electronic mail message based on at least one digital right associated with the electronic mail message;
select a portion of the electronic mail message that the user is authorized to receive; and
provide the selected portion of the electronic mail message to the first processor based device.

31. The system of claim 30, wherein the second processor-based device is a server, and further comprising a network, and wherein the server and the at least one first processor-based device are communicatively coupled via the network.

32. The system of claim 30, wherein the second processor-based device is adapted to queue the electronic mail message.

33. The system of claim 30, further comprising a storage unit, and wherein the second processor-based device is adapted to provide the electronic mail message to the storage unit.

34. A method for interfacing with a user of a computer system having a graphical user display, comprising:
displaying at least one indicator of a digital rights management rule associated with at least one portion of at least one electronic mail message;
monitoring the position and selection status of a pointer controller to detect that at least one of the at least one indicators has been selected by the user; and
providing an indication of a user authorization associated with the at least one portion of the at least one electronic mail message and the digital rights management rule in response to detecting that at least one of the at least one indicators has been selected by the user.

35. The method of claim 34, wherein providing the indication of the user authorization comprises providing at least one of an option to acquire one or more digital rights and an option to downcast the at least one portion of the at least one electronic mail message.

36. The method of claim 34, further comprising providing an option to modify the digital rights management rule associated with the at least one portion of the at least one electronic mail message in response to detecting that at least one of the at least one indicators has been selected by the user.

37. The method of claim 34, further comprising controlling a pointer element on the graphical user display with a user pointer controller, the pointer controller having position and selection status responsive to operation by the user.

38. The method of claim 34, wherein displaying the at least one indicator of the indication of the user authorization associated with the at least one portion of the at least one electronic mail message and the digital rights management rule comprises displaying at least one of a closed-lock icon and an open-lock icon.
